(19) United States
(12) Patent Application Publication
(10) Pub. No.: US 2006/0274860 A1
(43) Pub. Date: Dec. 7, 2006

(54) Wireless communications apparatus

(75) Inventors: Cheran Malsri Vithanage, Bristol (GB); Christophe Andrieu, Bristol (GB); Robert Jan Piechocki, Bristol (GB); Mong Suan Yee, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/412,965

(22) Filed: Apr. 28, 2006

(30) Foreign Application Priority Data
Jun. 2, 2005 (GB) 0511282.6

(51) Int. Cl. H04L 27/06

(52) U.S. Cl. 375/340

(57) ABSTRACT

A symbol based communications system involves symbol detection at a receiver in the system. The symbol detection involves determining a set of symbols likely to be present on a sequence of received data. A symbol detector provided to fulfil this role includes means for performing a forward backward recursion means on the basis of a reduced set of active states, to determine state probabilities in a hidden Markov model state trellis. The symbol detector further comprises forward message determination means operable to determine a reduced set of forward messages associated with a set of the available states for performance of the reduced state forward recursion, and backward message determination means operable, independently of the forward message determination means, to determine a reduced set of backward messages associated with a backward message determination means for performance of the reduced state backward recursion.

The present invention relates to wireless communications and more particularly to the decoding of signals transmitted over a wireless communications channel wherein the decoding is carried out on the basis of a symbol trellis using a variant of the BCJR procedure.

A trellis diagram comprises a sequence of sets of states indexed by time, the states representing states of a data encoder and transitions between the states representing encoded data. A trellis is therefore a representational tool assisting in the process of detecting encoded data that has been received at a receiver from transmission over a wireless channel.

A trellis decoder generally (but not necessarily) provides information on the probability of data symbols (transitions) or of individual trellis states since such soft information can be used as a priori information for iteratively improving a decoding process.

The states are hidden, in the sense that they cannot be directly measured or treated as received data. It is the object of symbol detection to determine, on the basis of observed data, the most likely identity of the states at the various trellis stages. A trellis diagram which represents an underlying hidden Markov model provides a suitable approach to this process.

A discrete random variable (d.r.v.) Xₜ, is a “state variable” in a Hidden Markov Model.

This means that it is not an observed variable of the system. FIG. 1 shows a simple probability distribution on the state variable Xₜ, by way of example. In this example, the domain or the configuration space of the variable Xₜ is the set {x₀, x₁, . . . , x₁₅}. Thus, the state of the discrete random variable Xₜ is one of the possible configurations of Xₜ, i.e. xᵢ for some iε[0,1, . . . ,15].

Further, the “support” of the distribution is the set of states of Xₜ that have a non zero probability. i.e. {xᵢ|p(Xₜ=xᵢ)>0}. In the example illustrated in FIG. 1, the support of the distribution is the set {x₂,x₃,x₅,x₆,x₇,x₉,x₁₀,x₁₁}.

A set of states can be defined in the domain of Xₜ. A set of states is a collection of elements from the domain of Xₜ. For example, {x₅,x₆,x₁₀,x₁₁} is a set of states in the present case.

It is possible to condition the distribution upon the realisation of some other variable. However, it is important to note that the conditioned distribution remains a distribution on the original variable. For example, p(Xₜ|y_{1:T}) is still a distribution on Xₜ.

In most wireless applications a channel codec is employed to improve the performance of the receiver. Therefore, for most receivers, especially iterative receivers, a soft output detector/decoder/equaliser is required to provide the soft input to the channel decoder. For an encoder with memory, the BCJR algorithm (L. Bahl, J. Cocke, F. Jelinek and J. Raviv, “Optimal decoding of linear codes for minimizing symbol error rate,” IEEE Trans. Information Theory, vol. 20, pp. 284-287, March 1974) is the optimal trellis-based decoder/detector. The BCJR procedure (named after the inventors thereof) provides trellis decoding assuming Markov data (where the evolution of a state depends on the current state but not its history).

The BCJR algorithm can be used in general to compute the marginal posterior distributions of states and pairs of consecutive states in a hidden Markov model (HMM), given a particular observation sequence. Since many problems in communications such as optimal channel decoding and optimal equalization of frequency selective channels can be formulated as the computation of these marginal posterior distributions, the BCJR algorithm has a wide scope for use.

By way of example, a system is described which arranges wireless communication across a channel between a single transmit antenna and a single receive antenna, where the channel memory is L. The fading coefficient of the d^{th} channel tap is denoted by h(d) for dε[0,L]. The received signal and the transmitted antenna symbol at the t^{th} time instance are denoted by yₜ and bₜ respectively.

In this case, it is assumed that the symbol bₜ is chosen from the set B={a₁, a₂, . . . , a_{N},} with cardinality N. The received signal yₜ consists of the convolution of the channel impulse response and a sequence of symbols transmitted up to L+1 time instants and an additive white Gaussian noise wₜ, i.e.:

$${y}_{t} = {\sum }_{d = 0}^{L} h ( d ) {b}_{t - d} + {w}_{t} \qquad ( 1 )$$

For convenience, the notation A_{t:t′} is used herein to refer to the sequence of some time indexed variables from time t to t′; t≦t′, i.e. A_{t:t′}={Aₜ, . . . , A_{t′})}. Assuming a frame transmission of T symbols, the optimal equalizer's task in this scenario is to consider the received signal sequence y_{1:T} and detect the transmitted symbols bₜ that maximize p(bₜ|y_{1:T}) for tε{1, . . . , T}.

Now, denoting vector transpose operation by (•)^{↑}, a state variable is defined for the equalizer at time t as Xₜ=(bₜ, . . . , b_{t-L+1})^{↑}.

Thus, each Xₜ takes values from a set S_{X}=B^{L} with cardinality |S_{X}|. It will be appreciated that this cardinality may be other than |S_{X}| in certain circumstances. The state variable sequence X_{0:T} (where X₀ denotes the initial state of the equalizer) forms a Markov chain with the conditional independence of p(yₜ|X_{1:t})=p(yₜ|Xₜ₋₁, Xₜ). Thus the variables concerned can be represented by a hidden Markov model. It can also be seen that the marginal posterior distributions of the transmitted symbols, p(bₜ|y_{1:T}) can also be derived directly from the distributions of p(Xₜ₋₁,Xₜ|y_{1:T}).

Thus the problem of optimal equalization can be formulated as the problem of efficient computation of the marginal posterior distributions of pairs of consecutive states of an HMM, and thus the BCJR algorithm can be applied as follows to obtain the optimal solution.

The BCJR algorithm involves a forward and a backward-recursion through the trellis formed by the possibilities of the state variable sequence X_{0:T}. In the forward recursion, the following recursive computations are made for each tε{1, . . . , T} and each XₜεS_{X}:

$$α ( {X}_{t} ) = {\sum }_{{X}_{t - 1} ∈ {S}_{X}} α ( {X}_{t - 1} ) γ ( {X}_{t - 1} , {X}_{t} ) , \qquad ( 2 )$$

where
γ(Xₜ₋₁,Xₜ)=p(Xₜ|Xₜ₋₁)p(yₜ|Xₜ₋₁,Xₜ). (3)

In the backward recursion, the following recursive computations are made for each tε{1, . . . , T} and each XₜεS_{X}:

$$β ( {X}_{t} ) = {\sum }_{{X}_{t + 1} ∈ {S}_{X}} β ( {X}_{t + 1} ) γ ( {X}_{t} , {X}_{t + 1} ) . \qquad ( 4 )$$

Note that α(Xₜ) and β(Xₜ) are considered as messages propagated in the two recursions. Finally the a posteriori probabilities of the state variables and pairs of consecutive state variables can be evaluated by:
p(Xₜ|y_{1:T})∝α(Xₜ)β(Xₜ) and (5)
p(Xₜ₋₁,Xₜ|y_{1:T})∝α(Xₜ₋₁)γ(Xₜ₋₁,Xₜ)β(Xₜ), (6)
for all Xₜ₋₁, XₜεS_{X} and tε{1, . . . , T}. From this, the marginal posterior distributions of the transmitted symbols for the particular example can be computed as:

$$p ( {b}_{t} \vert {y}_{1 : T} ) = \frac{1}{{Z}_{t}} {\sum }_{( {X}_{t - 1} , {X}_{t} ) ∈ ( {b}_{t} )} p ( {X}_{t - 1} , {X}_{t} \vert {y}_{1 : T} ) , \qquad ( 7 )$$

where the set ζ(bₜ) represents the set of pairs of (Xₜ₋₁, Xₜ) that result in the transmission of the symbol bₜ, and Zₜ is the normalization constant.

It can also be noted that normalization of the a posteriori probabilities set out above would provide proper marginal posterior distributions of state variables and pairs of consecutive state variables of the HMM.

The definitive BCJR algorithm is an efficient and optimal algorithm for maximum a posteriori state estimation under the assumption of a hidden Markov chain with a discrete state space. It solves a trellis representation of the system by a forward recursion through each trellis stage (successive trellis stages corresponding to successive time instants) followed by a backward recursion through the trellis stages. This is described in more detail later. However, in many applications, the identity of a state at a particular trellis stage may be from a large number of possibilities. Although the complexity of this algorithm is linear in time T, it is also related to |S_{X}|. In order to achieve improvement of this situation, a reduced state version of the BCJR algorithm is often used—this renders the recursion computations less dependent on |S_{X}|.

Since the ‘pure’ or definitive BCJR algorithm has a substantial computational cost, for a system represented by a large trellis, such as, for example, for a broadband system or a MIMO system, reduced complexity variations are used for practical implementations. Various reduced complexity algorithms have been proposed and implemented, involving a state reduction process to reduce computational complexity. These so-called reduced state BCJR algorithms include M-BCJR and T-BCJR algorithms.

These algorithms have a forward recursion and a backward recursion similar to the BCJR algorithm, and similar computations are performed. However, in the forward recursion a set of active states is selected by the algorithm for each time instance, as the support of the forward messages. The active states are selected by a computable approximation of the forward messages, α(Xₜ) themselves.

The M-BCJR algorithm is described in V. Franz and J. B. Anderson, “Concatenated decoding with a reduced-search BCJR algorithm,” (IEEE Journal on Selected Areas in Commun., vol. 16, pp. 186-195, February 1998), which computes the recursions in the BCJR algorithm for only M states (a subset of the full set of trellis states) at every trellis stage. The M states are selected based on a metric of the BCJR algorithm, more particularly at a time t selecting the M states with the largest forward recursion parameter aαₜ. This M-BCJR algorithm is able to perform well when the memory of the system is low (i.e. the channel impulse response is short), but performs poorly when the memory increases; the authors conclude that this approach is “not successful”. In an alternative approach described in the same paper (T-BCJR), only states with the forward recursion parameter αₜ greater than a threshold are selected, but the authors note that this approach has the disadvantage that the computation can vary widely, which can present difficulties in certain applications, particularly in a hardware implementation with a maximum cycle rate.

The set of active states selected at time instance t is denoted by Ωₜ, and the set of states that contend to be active states of time t by Ξₜ. In the case that Ωₜ₋₁ has been selected, and the corresponding forward message for time t−1 is \tilde{α}(Xₜ₋₁), the forward recursion of the M and T-BCJR algorithms at time instance t is now described. In the following analysis, the final approximation of a quantity of interest is denoted by the use of a tilde sign (~).

First, the temporary forward messages (for states in a set Ξₜ) of time t is computed as:

$$\hat{α} ( {X}_{t} ) = {\sum }_{{X}_{t - 1} ∈ {Ω}_{t - 1}} \tilde{α} ( {X}_{t - 1} ) γ ( {X}_{t - 1} , {X}_{t} ) . \qquad ( 8 )$$

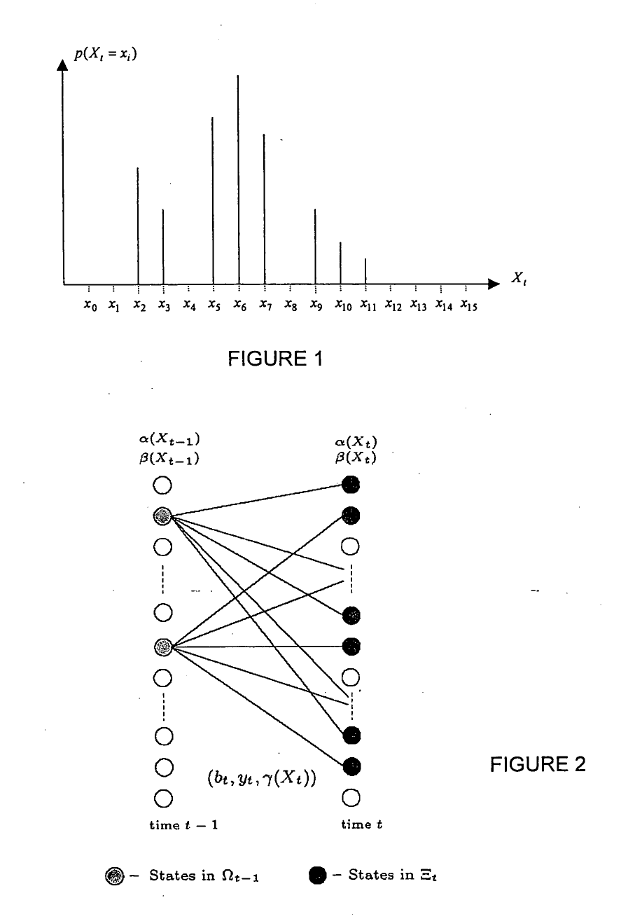

The set Ξₜ is the union of the supports in Xₜ of γ(Xₜ₋₁, Xₜ) for Xₜ₋₁εΩₜ₋₁. FIG. 2 shows a section of the equalizer trellis of the present example (the trellis diagram shows the configuration space of the state variables vertically), showing the sets Ωₜ₋₁ and Ξₜ.

Now, the M-BCJR algorithm selects M states out of Ξₜ based on the M largest values of \hat{α}(Xₜ), and including the corresponding states in Ωₜ. In contrast, the T-BCJR algorithm selects a variable number of active states corresponding to the values \hat{α}(Xₜ) that exceed a predetermined threshold T. Thus, the forward messages are:

$$\{ \begin{matrix}\tilde{α} ( {X}_{t} ) = \hat{α} ( {X}_{t} ) & for {X}_{t} ∈ {Ω}_{t} \\ \tilde{α} ( {X}_{t} ) = 0 & for {X}_{t} ∉ {Ω}_{t}\end{matrix} \qquad ( 9 )$$

Since this is the only difference between these two algorithms, further discussion is focussed on the M-BCJR algorithm for simplicity.

This recursion results in the selection of a sequence of active states for each time instance, resulting in Ω_{1:T}. Also, the forward messages can be considered as having a sparse representation with the support reduced from |S_{X}| to M. The backward recursion and the computations of p(Xₜ₋₁, Xₜ|y_{1:T}) and p(Xₜ|y_{1:T}) are only computed for states in these selected active states. Thus, the complexity of the algorithm is related to M instead of |S_{X}|. This delivers an adjustable complexity to the algorithm. However, in practice, to achieve near optimal performance for systems with substantial memory, the M value need to be a significant proportion of |S_{X}|.

It is also noted that, since α(Xₜ)∝p(Xₜ|y_{1:t}), the active state selection of M-BCJR is based on the filtered probability distribution of the state variables at each time instance.

Thus, in general, reduced complexity methods known in the art are perceived to suffer from performance degradation due to loss of information when the trellis states are reduced. Also, the performance of these methods is dependent on the memory and energy distribution of the ‘encoder’.

The M- or T-BCJR algorithms select a set of active states in the forward recursion based on the filtered probability distribution of the states. This implies that only the received signals up to the time instant under consideration are taken into account, when deciding on the set of active states. It will be appreciated that it is better to consider the future received signals as well.

The present invention looks to address the problems set out above.

A first aspect of the invention provides a symbol detector for use in a receiver in a communications system, the symbol detector being operable to determine a set of symbols likely to be present on a sequence of received data, the symbol detector including reduced state forward backward recursion means operable to determine state probabilities in a hidden Markov model state trellis, and further comprising forward message determination means operable to determine a reduced set of forward messages associated with a set of the available states for performance of the reduced state forward recursion, and backward message determination means, operable independently of the forward message determination means, operable to determine a reduced set of backward messages associated with a backward message determination means for performance of the reduced state backward recursion.

A second aspect of the invention provides a method of decoding symbols of a received signal in accordance with a trellis based process, said symbol being a sequence of transitions between states of said trellis, the method comprising determining, for a given time instance, an estimate of the marginal posterior distribution of states at that time instance, selecting active states from the set of states in the trellis, said step of selecting active states using said marginal posterior distribution of states at that time instance, then computing forward and backward messages for the selected states for performance of a forward backward recursion to thereby determine state probabilities in said trellis.

An aspect of the present invention provides a forward-backward recursive channel decoder operable to perform a forward recursion on the basis of a currently available approximation of the marginal posterior distributions p(Xₜ|y_{1:T}) based on the “expectation propagation” concept as presented in T. Heskes and O. Zoeter, “Expectation propagation for approximate inference in dynamic bayesian networks,” (Proceedings of UAI-2002, A. Darwiche and N. Friedman, Eds., 2002, pp. 216-233). In accordance with this aspect of the invention, the decoder is operable to perform the backward recursion on the basis of a set of active states selected independently from the set of active states employed in the forward recursion. The decoder is operable to perform the forward recursions and the backward recursions iteratively until the algorithm reaches a fixed point.

In order to achieve independent selection of the sets of active states for use in the forward and backward recursions, the forward/backward messages of inactive states may be set to a predetermined value (say η). This contrasts with the M-BCJR algorithm which renders the messages associated with inactive states to zero.

While the invention may be implemented by means of application specific electronic or other devices, it is also the case that implementation can be effected on conventional hardware, suitably configured by computer executable instructions.

Specific embodiments will now be described, by way of example and intended to be illustrative of the invention, with reference to the accompanying drawings, in which:

FIG. 1 is a graph illustrating a probability distribution on a discrete random variable such as may be received through transmission across a wireless communications channel, as described in the introduction above;

FIG. 2 is a schematic diagram representing a section of an equalizer trellis of the example used and described in the introduction above;

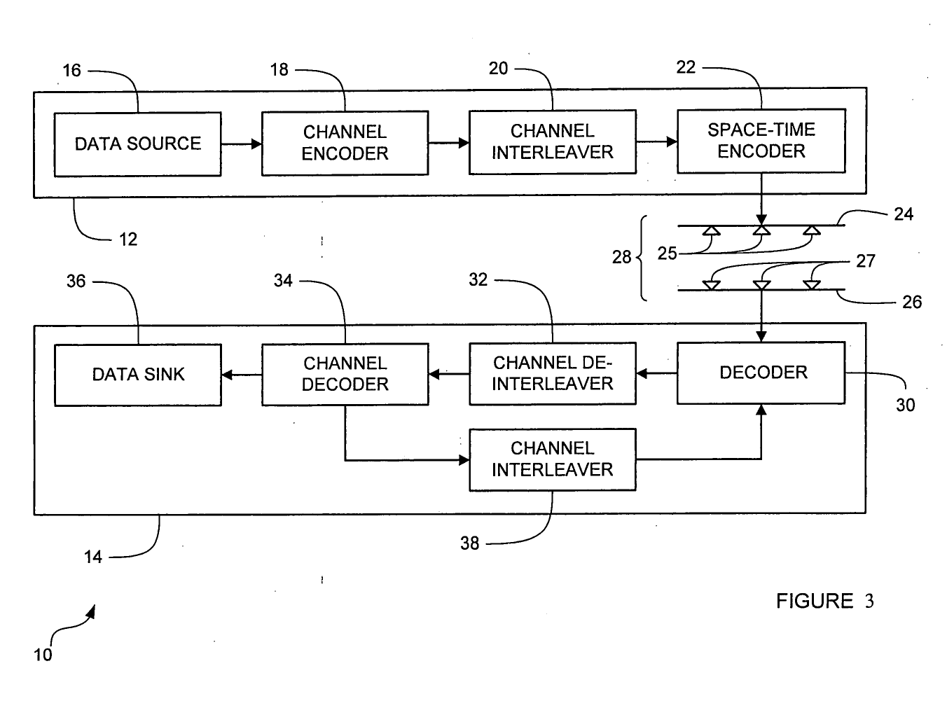

FIG. 3 is a schematic diagram of a communications system in accordance with a specific embodiment of the invention including a transmitter and a receiver in wireless communication;

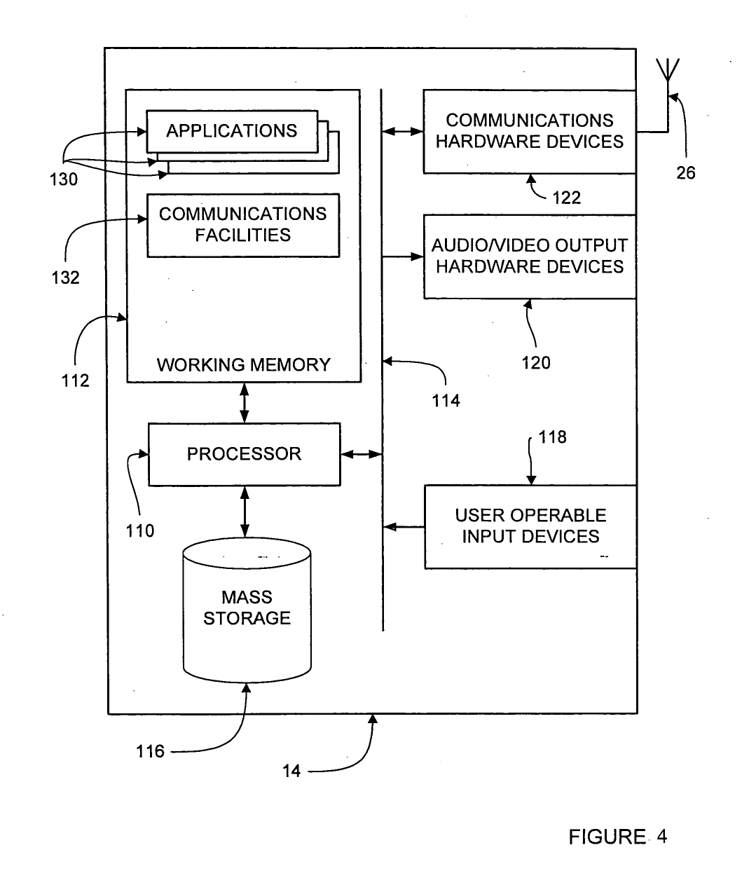

FIG. 4 is a schematic diagram of the receiver illustrated in FIG. 3;

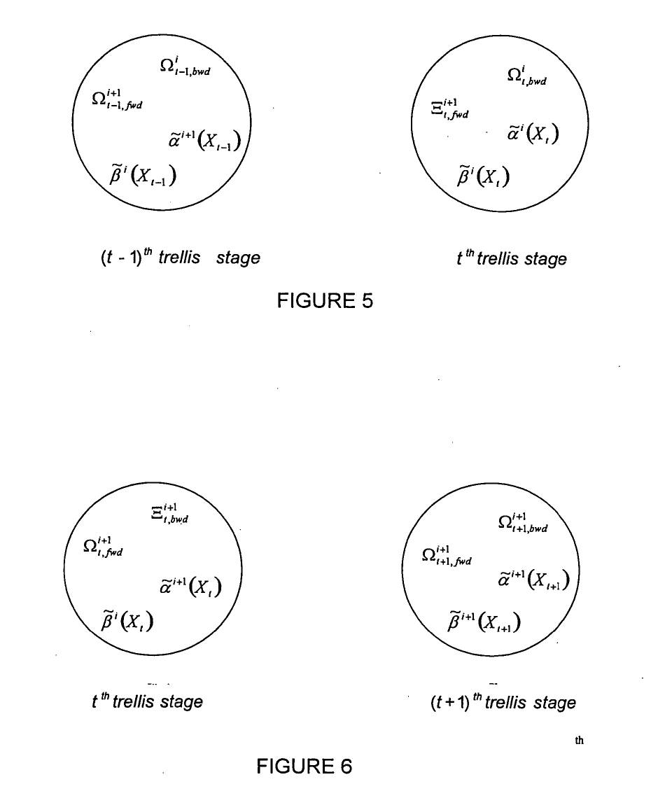

FIG. 5 is a state diagram illustrating the states available for forward recursion at a particular time instance used in the operation of the described embodiment of the present invention;

FIG. 6 is a state diagram illustrating the states available for backward recursion at said time instance used in the operation of the described embodiment of the present invention;

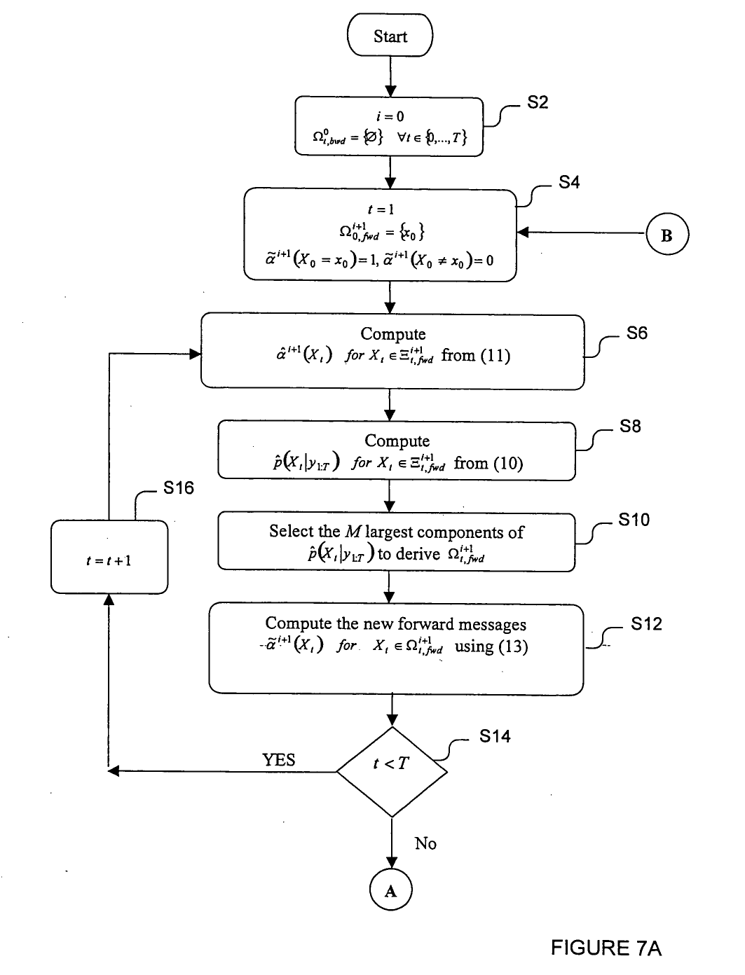

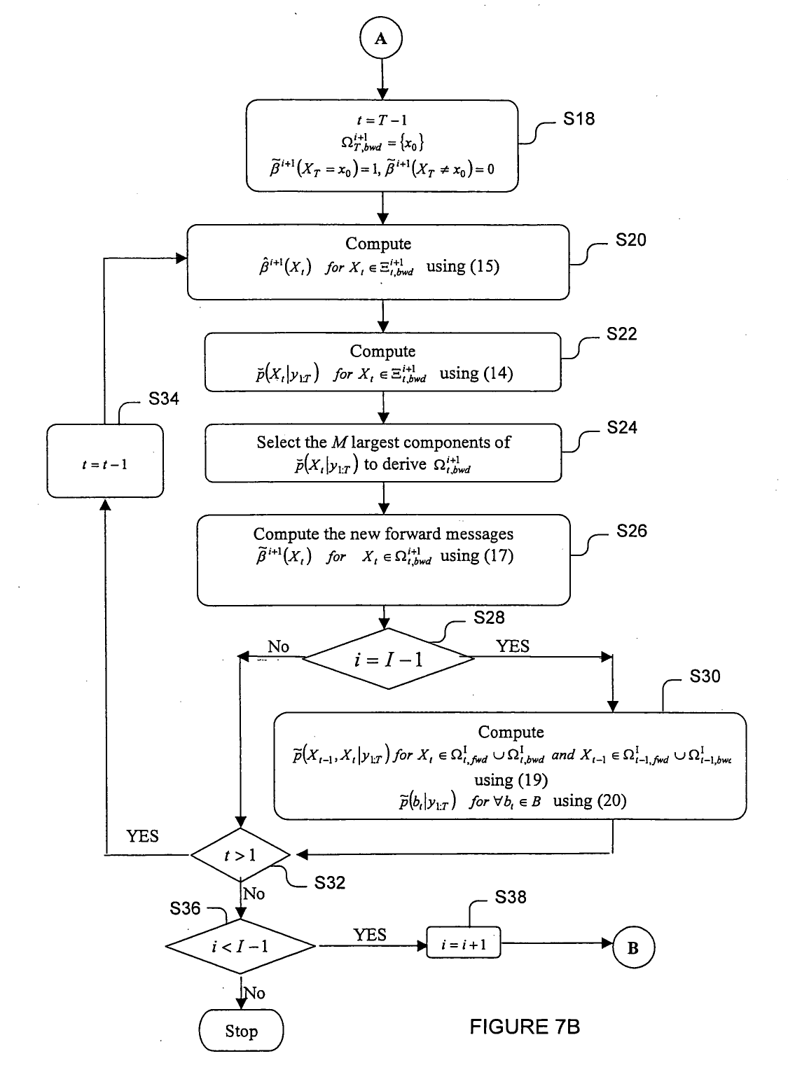

FIG. 7 is a flow diagram of a process of symbol detection in accordance with the described embodiment of the present invention; and

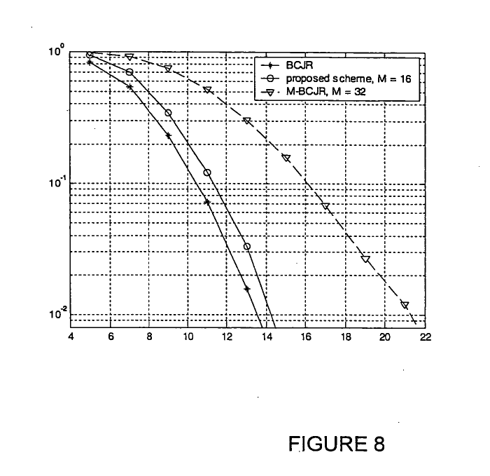

FIG. 8 is a graph illustrating performance of the described embodiment of the present invention as modelled in a simulation environment against performance of symbol detection processes contained in the art.

The present invention will now be described with reference to an implementation thereof for the equalization of a wireless communication system. FIG. 3 illustrates such a system, comprising a MIMO data communications system 10 of generally known construction. New components, in accordance with a specific embodiment of the invention, will be evident from the following description.

The communications system 10 comprises a transmitter device 12 and a receiver device 14. It will be appreciated that in many circumstances, a wireless communications device will be provided with the facilities of a transmitter and a receiver in combination but, for this example, the devices have been illustrated as one way communications devices for reasons of simplicity.

The transmitter device 12 comprises a data source 16, which provides data (comprising information bits or symbols) to a channel encoder 18. The channel encoder 18 in this example comprises a convolutional coder such as a recursive systematic convolutional (RSC) encoder, or a stronger so-called turbo encoder (which includes an interleaver). More bits are output than are input, and typically the rate is one half or one third.

The channel encoder 18 is followed by a channel interleaver 20 and, in the illustrated example, a space-time encoder 22. The space-time encoder 22 encodes an incoming symbol or symbols as a plurality of code symbols for simultaneous transmission from a transmitter antenna array 24 comprising a plurality of transmit antennas 25. In this illustrated example, three transmit antennas 25 are provided, though practical implementations may include more, or less antennas depending on the application.

The encoded transmitted signals propagate through a MIMO channel 28 defined between the transmit antenna array 24 and a corresponding receive antenna array 26 of the receiver device 14. The receive antenna array 26 comprises a plurality of receive antennas 27 which provide a plurality of inputs to a decoder 30 of the receiver device 14. In this specific embodiment, the receive antenna array 26 comprises three receive antennas 27.

The decoder 30 has the task of removing the effect of the encoder 22. The output of the decoder 30 comprises a plurality of signal streams, one for each transmit antenna 25, each carrying so-called soft or likelihood data on the probability of a transmitted symbol having a particular value. This data is provided to a channel de-interleaver 32 which reverses the effect of the channel interleaver 20, and the convolutional code output by this channel de-interleaver 32 is then presented to a channel decoder 34, in this example a Viterbi decoder, which decodes the convolutional code.

The specific function of the decoder 30 will be described in due course.

Typically, the channel decoder 34 is a SISO (soft-in soft-out) decoder, that is operable to receive symbol (or bit) likelihood data and to provide similar likelihood data as an output rather than, say, data on which a hard decision has been made. The output of channel decoder 34 is provided to a data sink 36, for further processing of the data in any desired manner.

Iterative decoding is employed in which a soft output from the channel decoder 34 is provided to a channel interleaver 38, corresponding to the channel interleaver 20, which in turn provides soft (likelihood) data to the space-time decoder 30 for iterative space-time (and/or frequency) and channel decoding. It will be appreciated that in this arrangement the channel decoder 34 provides complete transmitted symbols to the space-time decoder 30, that is, for example, including error check bits.

FIG. 4 illustrates schematically hardware operably configured (by means of software or application specific hardware components) as the receiver device 16. The receiver device 16 comprises a processor 110 operable to execute machine code instructions stored in a working memory 112 and/or retrievable from a mass storage device 116. By means of a general purpose bus 114, user operable input devices 118 are capable of communication with the processor 110. The user operable input devices 118 can comprise, in this example, a keyboard, a mouse or other pointing device, a writing tablet, speech recognition means, or any other means by which a user input action can be interpreted and converted into data signals.

Audio/video output hardware devices 120 are further connected to the general purpose bus 114, for the output of information to a user. Audio/video output hardware devices 120 can include a visual display unit, a speaker or any other device capable of presenting information to a user.

Communications hardware devices 122, connected to the general purpose bus 114, are connected to the antenna 26. In the illustrated embodiment in FIG. 2, the working memory 112 stores user applications 130 which, when executed by the processor 110, cause the establishment of a user interface to enable communication of data to and from a user. The applications in this embodiment establish general purpose or specific computer implemented utilities that might habitually be used by a user.

Communications facilities 132 in accordance with the specific embodiment are also stored in the working memory 112, for establishing a communications protocol to enable data generated in the execution of one of the applications 130 to be processed and then passed to the communications hardware devices 122 for transmission and communication with another communications device. It will be understood that the software defining the applications 130 and the communications facilities 132 may be partly stored in the working memory 112 and the mass storage device 116, for convenience. A memory manager could optionally be provided to enable this to be managed effectively, to take account of the possible different speeds of access to data stored in the working memory 112 and the mass storage device 116.

On execution by the processor 110 of processor executable instructions corresponding with the communications facilities 132, the processor 110 is operable to establish communication with another device in accordance with a recognised communications protocol.

In the described embodiment, whereas a decoder selects a fixed number of active states at each time instance, similar to the approach taken in accordance with the M-BCJR algorithm, it will be appreciated that, similar to the approach taken in accordance with the T-BCJR algorithm, the selection approach could comprise selecting a variable number of active states based on a selection criterion as discussed in relation with the T-BCJR algorithm in [2].

In the described embodiment, the equaliser performs a total of I iterations of the forward backward recursion and have computed forward and backward messages \tilde{α}ⁱ(Xₜ) and \tilde{β}ⁱ(Xₜ) at the i^{th} iteration of the algorithm for every tε{1, . . . , T}. The sets of active states of the forward and backward recursions, in the i^{th} iteration of the algorithm and at the t^{th} time instant, are denoted by Ω_{t,fwd}ⁱ and Ω_{t,bwd}ⁱ respectively, and Ξ_{t,fwd}ⁱ and Ξ_{t,bwd}ⁱ denote the sets of states contending to be the active states in forward and backward recursions respectively.

At the t^{th} time instance in the forward recursion, forward messages are computed as of time t−1 in the (i+1)^{th} iteration as \tilde{α}ⁱ⁺¹(Xₜ₋₁) for Xₜ₋₁εΩ_{t-1,fwd}ⁱ⁺¹ and backward messages are computed as of time t in the i^{th} iteration as \tilde{β}(Xₜ) for XₜεΩ_{t,bwd}ⁱ.

FIG. 5 sets out the sets of states available at the beginning of the t^{th} time instance in the forward recursion of the (i+1)^{th} iteration, and relevant computations.

Thus, for XₜεΞ_{t,fwd}ⁱ⁺¹, the current approximation of the marginal posterior distributions of the state variables is determined as:
\hat{p}(Xₜ|y_{1:T})∝\hat{α}ⁱ⁺¹(Xₜ)\tilde{β}^{t}(Xₜ) for XₜεΞ_{t,fwd}ⁱ⁺¹. (10)
wherein preliminary computations have been performed to determine \hat{α}ⁱ⁺¹(Xₜ) as:

$${\hat{α}}^{i + 1} ( {X}_{t} ) = {\sum }_{{X}_{t - 1} ∈ {Ω}_{t - 1 , fwd}^{i + 1}} {\tilde{α}}^{i + 1} ( {X}_{t - 1} ) γ ( {X}_{t - 1} , {X}_{t} ) \\ for \\ {X}_{t} ∈ {Ξ}_{t , fwd}^{i + 1} , \qquad ( 11 )$$

assuming that \tilde{β}ⁱ(Xₜ)=η for XₜεΞ_{t,fwd}ⁱ⁺¹\Ω_{t,bwd}ⁱ. (12)

Then, the decoder selects the M largest components of \hat{p}(Xₜ|y_{1:T}) and includes the corresponding configurations of Xₜ in Q_{t,fwd}ⁱ⁺¹, making them the selected active states. The new forward messages area computed as:

$${\tilde{α}}^{i + 1} ( {X}_{t} ) = \frac{\hat{p} ( {X}_{t} \vert {y}_{1 : T} )}{{\tilde{β}}^{i} ( {X}_{t} )} \\ for \\ {X}_{t} ∈ {Ω}_{t , fwd}^{i + 1} \qquad ( 13 )$$

likewise assuming that \tilde{β}ⁱ(Xₜ)=η for XₜεΞ_{t,fwd}ⁱ⁺¹\Ω_{t,bwd}ⁱ.

Similarly, the forward active states and forward messages of each time instance are recursively updated.

As illustrated, this is achieved by considering backward messages of time t+1 in the (i+1)^{th} iteration as \tilde{β}ⁱ⁺¹(Xₜ₊₁) for Xₜ₊₁εΩ_{t+1,bwd}ⁱ⁺¹ and forward messages of time t in the (i+1)^{st} iteration as \tilde{α}ⁱ⁺¹(Xₜ) for XₜεΩ_{t,fwd}ⁱ⁺¹.

With regard to the backward recursion, the backward active state selection will now be described, along with backward message computation of the t^{th} time instance in the (i+1)^{th} iteration.

FIG. 6 sets out the sets of states available at the beginning of the t^{th} time instance in the backward recursion of the (i+1)^{th} iteration, and relevant computations. Thus, for XₜεΞ_{t,bwd}ⁱ⁺¹, the current approximation of the marginal posterior distributions of the state variables is determined as
\overline{p}(Xₜ|y_{1:T})∝\tilde{α}ⁱ⁺¹(Xₜ)\hat{β}ⁱ⁺¹(Xₜ) for XₜεΞ_{t,bwd}ⁱ⁺¹ (14)
where

$${\hat{β}}^{i + 1} ( {X}_{t} ) = {\sum }_{{X}_{t + 1} ∈ {Ω}_{t + 1 , bwd}^{i + 1}}^{} {\tilde{β}}^{i + 1} ( {X}_{t + 1} ) γ ( {X}_{t - 1} , {X}_{t} ) for {X}_{t} ∈ {Ξ}_{t , bwd}^{i + 1} \qquad ( 15 )$$

and assuming
\tilde{α}ⁱ⁺¹(Xₜ)=η for XₜεΞ_{t,bwd}ⁱ⁺¹\Ω_{t,fwd}ⁱ⁺¹. (16)

Then, the detector selects the M largest components of \hat{p}(Xₜ↑y_{1:T}) and includes the corresponding configurations of Xₜ in Ω_{t,bwd}ⁱ⁺¹, making them the selected active states. This results in new backward messages, comprising:

$${\tilde{β}}^{i + 1} ( {X}_{t} ) = \frac{\overline{p} ( {X}_{t} \vert {y}_{1 \text{:} T} )}{{\tilde{α}}^{i + 1} ( {X}_{t} )} for {X}_{t} ∈ {Ω}_{t , bwd}^{i + 1} , \qquad ( 17 )$$

likewise assuming
\tilde{α}ⁱ⁺¹(Xₜ)=η for XₜεΞ_{t,bwd}ⁱ⁺¹\Ω_{t,fwd}ⁱ⁺¹. (16)

As with the forward recursion stage, the backward active states and backward messages of each time instance are then updated recursively. During the backward recursion of the I^{th} iteration, the final estimates of the marginal posterior distributions of the state variables and pairs of consecutive state variables are computed as:
\tilde{p}(Xₜ|y_{1:T})∝\tilde{α}^{I}(Xₜ)\tilde{B}^{I}(Xₜ) for XₜεΩ_{t,fwd}^{I}∪Ω_{t,bwd}^{I} (18)
and
\tilde{p}(Xₜ₋₁,Xₜ|y_{1:T})∝\tilde{α}^{I}(Xₜ₋₁)γ(Xₜ₋₁,Xₜ)\tilde{β}^{I}(Xₜ) (19)
for XₜεΩ_{t,fwd}^{I}∪Ω_{t,bwd}^{I} and Xₜ₋₁εΩ_{t-1,fwd}^{I}∪Ω_{t-1,bwd}^{I}.

This is subject to the understanding that the forward/backward message of a state which is not in the forward/backward set of active states is set to the value η. Finally, the marginal posterior distributions of the transmitted symbols are estimated as:

$$\tilde{p} ( {b}_{t} \vert {y}_{1 : T} ) = \frac{1}{{Z}_{t}^{I}} {\sum }_{( {X}_{t - 1} , {X}_{t} ) ∈ {}^{I} ( {b}_{t} )} \tilde{p} ( {X}_{t - 1} , {X}_{t} \vert {y}_{1 : T} ) \\ for \\ ∀ {b}_{t} ∈ B , \qquad ( 20 )$$

where the set ζ^{I}(bₜ) represents the set of pairs of (Xₜ₋₁,Xₜ) that result in the transmission of the symbol bₜ, and Zₜ^{I} is the normalization constant.

For trellis terminated systems (say at state x₀) Ω_{0,fwd}ⁱ and Ω_{T,fwd}ⁱ are set to:
Ω_{0,fwd}ⁱ=Ω_{0,bwd}ⁱ={x₀} (21)
and
Ω_{T,fwd}ⁱ=Ω_{T,bwd}ⁱ={x₀} for iε{0, . . . , I}. (22)

For the avoidance of doubt, the number I can be predetermined or determined dynamically based on a suitable stopping rule. For example, it could be suitable to stop the recursion when there is no significant changes in the selected active states of the backward recursion. However, for simplicity, in the following specific example of implementation of the methodology described above, the number of iterations is predetermined.

The process set out by way of the flow diagram of FIGS. 7A and 7B (considered as two parts of one FIG. 7) is operable to perform the equalization of a wireless communication system with a fixed number of active states at each time instance. The process commences on the basis of the receipt at the channel equaliser of a sequence y_{1:T}.

In a first step S2, the parameters M,η and I are set. By this, an iteration counter i is initialised, i.e. i=0. Further, Ω_{t,bwd}⁰ is initialised:
Ω_{t,bwd}⁰={Ø} ∀tε{0, . . . , T}.

Then, in step S4, t is set to 1, Ω_{0,fwd}ⁱ⁺¹ is set to {x₀} and \tilde{α}ⁱ⁺¹ is set according to:
\tilde{α}ⁱ⁺¹(X₀=x₀)=1 and
\tilde{α}ⁱ⁺¹(X₀≠x₀)=0.

Then, in step S6, forward messages \hat{α}ⁱ⁺¹(Xₜ) (for XₜεΞ_{t,fwd}ⁱ⁺¹) are computed using the formula set out above in equation 11.

In step S8, the probabilities \hat{p}(Xₜ|y_{1:T}) for XₜεΞ_{t,fwd}ⁱ⁺¹ are computed using (10). The M largest components of \hat{p}(Xₜ|y_{1:T}) are then selected in step S10. This selection step causes the creation of a set Ω_{t,fwd}ⁱ⁺¹ of states in the domain.

Following selection of the set to be used for forward recursion, in step S12, the forward messages \tilde{α}ⁱ⁺¹ (Xₜ) are computed for XₜεΩ_{t,fwd}ⁱ⁺¹ using (13).

In step S14, a decision is taken on the basis of the time t under consideration. If t<T, then t is incremented by one in step S16 and the process returns to step S6. Otherwise, the process continues to Step S18 (FIG. 7B overleaf from FIG. 7A), wherein t is set to T−1. In the same step, the process sets Ω_{T,bwd}ⁱ⁺¹={x₀}, \tilde{β}ⁱ⁺¹(X_{T}=x₀)=1 and \tilde{β}ⁱ⁺¹(X_{T}≠x₀)=0.

The process continues in step S20 by computing backward messages \hat{β}ⁱ⁺¹(Xₜ) for XₜεΞ_{t,bwd}ⁱ⁺¹ using (15). Then, in step S22, the probabilities \check{p}(Xₜ|y_{1:T}) are computed for XₜεΞ_{t,bwd}ⁱ⁺¹ using (14). As for the forward messages, the M largest components of \check{p}(Xₜ|y_{1:T}) are selected in step S24, thereby determining the set Ω_{t,bwd}ⁱ⁺¹ for backward recursion.

Once the set of states for backward recursion has been determined then, in step S26, the backward messages \tilde{β}ⁱ⁺¹(Xₜ) are computed for XₜεΩ_{t,bwd}ⁱ⁺¹, using (17).

In step S28, a determination is made as to the value of i. If i=I−1, then in step S30 the process computes \tilde{p}(Xₜ₋₁,Xₜ|y_{1:T}) from (19) and \tilde{p}(bₜ|y_{1:T}) for ∀bₜεB from (20). Otherwise, this computation is not performed and step S30 is bypassed.

Then, the process continues in step S32 by determining if t>1. If so, then t is decreased by one in step S34 and the process returns to step S20. Otherwise the process continues to step S36 in which, if i<I−1, then i is increased by one in step S38 and then the process returns to step S6. If, on the other hand, i=I, then the process ends.

FIG. 8 illustrates examples of use of the process described above in a simulation environment, in a turbo equalization scheme. In a turbo equalizer, iterations exist between the equalizer and the channel decoder. The present invention can be naturally integrated to the iterations of the turbo equalizer.

In the illustrated simulations, two iterations have been performed within the equalizer during the first global turbo equalization iteration. Afterwards, only single forward and backward recursions have been carried out within the equalizer. Also, after the first global turbo iteration, the simulation uses a sequence of active states and messages of the backward recursion of the previous global turbo iteration, for the forward recursion of the proposed algorithm.

FIG. 8 shows the simulation of the BCJR, M-BCJR with 32 active states and the equalisation process described above, with 16 active states in a 5 tap uniform delay profile quasistatic Rayleigh fading channel with 8PSK symbol transmission. For comparison, the optimal equalizer (BCJR) has a total of 4096 states. The results shown are after 5 turbo equalization iterations. It should be noted that the described system and the conventional M-BCJR system have a similar computational complexity in this example, but that the described embodiment provides improved performance, substantially the same as the optimal approach rather than similar to the M-BCJR approach.

In summary, the present invention is concerned with deciding of a signal resultant from communication across a communication channel. While the specific examples are shown in the context of a wireless communication channel, it will be appreciated by the reader that this should not be regarded as a limitation on the application of the invention.

Optimal decoding of many components in a communication receiver (e.g. channel decoder and equalizer) can be formulated as the problem of finding the marginal posterior distributions of state variables and pairs of consecutive state variables of a hidden Markov model (HMM). The BCJR algorithm is an efficient algorithm for computing these required marginal posterior distributions. However, this algorithm is generally held to be impractical as it suffers from intractable complexity in most practical situations. Therefore reduced complexity versions of the BCJR algorithm have been identified, providing acceptable decoding reliability at the cost of an acceptable reduction in performance. One such algorithm is the M-BCJR algorithm, in which a set of active states is selected at each time instance in the forward recursion and the computations are carried mostly for these selected active states. that way, the system designer is provided with controllable and adjustable complexity.

The present invention provides a decoder which employs a reduced state forward-backward recursion algorithm, the decoder then providing improved performance over previously identified reduced state decoding, while using only a fraction of the complexity of the full state BCJR algorithm. To do this, the decider of an aspect of the present invention uses approximations of the marginal posterior distribution of the state variables, for the selection of the active states. One embodiment allows different state selections in each recursion of the algorithmn. In that way, the algorithm is able to recover from possibly inappropriate active state selections, thereby reducing information loss resultant from premature state selection.

Embodiments of the invention have various applications in communications systems, turbo decoders (e.g. required for UMTS, wireless LAN standard) and equalizers (e.g. required for EDGE standard). Moreover, being applicable to any application that involves the computation of marginal posterior distributions of state variables and pairs of consecutive state variables, the present invention is applicable to various other applications such as speech recognition.

For avoidance of doubt, the specific embodiment is described by way of example, and it will be appreciated that variations on and modifications of the specific features may be provided in the alternative or in addition without falling outside the intended scope of the invention. The scope of protection sought is rather to be defined by the wording of the claims appended hereto, as construed in the light of the foregoing and with reference to the accompanying drawings.

1. A receiver for use in a communications system, the receiver including symbol detection means operable to determine a set of symbols likely to be present on a sequence of received data, the symbol detection means including reduced state forward backward recursion means operable to determine state probabilities in a hidden Markov model state trellis, and the symbol detection means further comprising forward message determination means operable to determine a reduced set of forward messages associated with a set of the available states for performance of the reduced state forward recursion, and backward message determination means operable, independently of the forward message determination means, to determine a reduced set of backward messages associated with a backward message determination means for performance of the reduced state backward recursion.

2. A receiver in accordance with claim 1 wherein the symbol detection means includes active state selection means operable to determine a set of active states, for use by the forward message determination means and by the backward message determination means.

3. A receiver in accordance with claim 2 wherein the active state selection means is operable to select a set of active states of the hidden Markov model on the basis of an approximation of the marginal posterior distribution of the state variables.

4. A receiver in accordance with claim 2 wherein the active state selection means is operable to set inactive states to a predetermined value.

5. A receiver in accordance with claim 4 wherein the active state selection means is operable to set inactive states to a predetermined, non-zero value.

6. A receiver in accordance with claim 1 wherein the reduced state forward backward recursion means is operable in accordance with a quasi-BCJR recursion process.

7. A method of detecting symbols on a sequence of data received from transmission over a communications channel, the method resulting in a set of symbols likely to be present on the sequence of received data, the method comprising applying a reduced state forward backward recursion process to determine state probabilities in a hidden Markov model state trellis, the method comprising determining a reduced set of forward messages associated with a set of the available states for performance of the reduced state forward recursion and, independently of the step of determining reduced set of forward messages, determining a reduced set of backward messages associated with a backward message determination means for performance of the reduced state backward recursion.

8. A method in accordance with claim 7 including selecting a set of active states for use in the step of determining a reduced set of forward messages and for use in the step of determining a reduced set of backward messages.

9. A method in accordance with claim 8 wherein the step of selecting a set of active states is performed on the basis of an approximation of the marginal posterior distribution of the state variables.

10. A method in accordance with claim 8 and including the step of setting states not selected as active states to a predetermined value.

11. A method in accordance with claim 10 wherein said predetermined value is non-zero.

12. A symbol detector for use in a receiver in a communications system, the symbol detector being operable to determine a set of symbols likely to be present on a sequence of received data, the symbol detector including reduced state forward backward recursion means operable to determine state probabilities in a hidden Markov model state trellis, and further comprising forward message determination means operable to determine a reduced set of forward messages associated with a set of the available states for performance of the reduced state forward recursion, and backward message determination means operable, independently of the forward message determination means, to determine a reduced set of backward messages associated with a backward message determination means for performance of the reduced state backward recursion.

13. A computer program product bearing computer executable instructions, the instructions being operable, when executed by a computer, to cause said computer to become configured to perform the method of claim 7.
